(19) United States
(12) Patent Application Publication
(10) Pub. No.: US 2005/0214667 A1
(43) Pub. Date: Sep. 29, 2005

(54) Method for evaluating coloring agent, coloring agent, and toner for electrostatic latent image development

(75) Inventors: Masateru Kawamura, Toyoake-shi (JP); Jun Ikami, Ichinomiya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/070,001

(22) Filed: Mar. 3, 2005

(30) Foreign Application Priority Data
Mar. 29, 2004 (JP) 2004-096377

(51) Int. Cl. B32B 1/00; G03G 9/09

(52) U.S. Cl. 430/108.3; 430/108.6; 430/137.1; 428/403; 428/405

(57) ABSTRACT

A coloring agent, which is obtained by treating an iron oxide surface with a coupling agent, is selected so that pH is 5.3 to 7.7, a surface coating ratio with the coupling agent is 26.7 to 81.6%, and a bulk change ratio is 30.9 to 50.0%. When a toner for electrostatic latent image development is produced by blending the selected coloring agent, it is possible to obtain the toner which is preferably useable in the development process based on the non-magnetic mono-component developing system.

### BACKGROUND OF THE INVENTION

1. Field of the Invention

The present invention relates to a method for evaluating a coloring agent, a coloring agent, and a toner for electrostatic latent image development.

2. Description of the Related Art

Conventionally, a toner, which contains a binder resin and iron oxide, is known as a toner for developing an electrostatic latent image (see, for example, Japanese Patent No. 3049865). Such a toner is called “magnetic toner”, which is principally used for an image-forming apparatus that adopts the magnetic mono-component developing system.

Iron oxide functions as a magnetic powder for giving the magnetization to the toner. Further, iron oxide functions as a black coloring agent as well. Therefore, iron oxide can be adopted as a black coloring agent even in the case of a toner which is used for an image-forming apparatus that adopts the non-magnetic mono-component developing system.

Further, Japanese Patent No. 3049865 also suggests that the surface of iron oxide is treated with a coupling agent in order to improve the dispersibility of iron oxide in the binder resin. The hydroxyl group exists on the surface of iron oxide. Therefore, iron oxide exhibits the hydrophilicity, and it is not necessarily compatible with the binder resin so much. However, when the surface of iron oxide is treated with the coupling agent, then the hydroxyl group on the iron oxide surface is masked, and the iron oxide surface becomes hydrophobic. Therefore, the dispersibility of iron oxide is improved in the binder resin.

When the surface of iron oxide is treated with the coupling agent as described above, the surface treatment state of iron oxide varies depending on various factors in combination, including, for example, the amount of use of the coupling agent and the degree of hydrolysis of the coupling agent. Therefore, the physical properties of iron oxide after the surface treatment are also dispersed depending on the difference in various conditions. For this reason, all of the iron oxides, to which the surface treatment has been applied with the coupling agent, are not always effective as coloring agents to be blended into the toner for electrostatic latent image development. It is necessary to select effective coloring agents.

However, any evaluating method has not been established yet, which is effective in order to select the coloring agent to be blended into the toner for electrostatic latent image development. That is, in the conventional technique, a toner is produced by using a coloring agent produced under any appropriately designed production condition, and then it is merely tried to actually perform the development of an electrostatic latent image and the transfer onto a recording medium, wherein any evaluation of the coloring agent itself has not been made in order to select the coloring agent to be blended into the toner for the electrostatic latent image.

In the case of an image-forming apparatus which adopts a cleaner-less electrostatic developing process provided with no cleaning blade for removing the toner remaining on the photosensitive member, if any failure arises in the transfer to the recording medium, and the toner remains on the photosensitive member, then any harmful influence is exerted on the quality of the image to be recorded on the recording medium, for example, such that the ghost (residual image or afterimage) appears when the recording is performed on the recording medium next time. Therefore, in the case of the image-forming apparatus of this type, it is important to use the toner with which the transfer failure is hardly caused.

However, no precedent has been investigated yet as well in relation to the relationship between the transfer failure and the physical properties of the coloring agent to be blended into the toner for electrostatic latent image development.

In such circumstances, the inventors have found out that no failure is caused in the transfer to the recording medium, and it is possible to improve the quality of the image to be recorded on the recording medium even in the case of the image-forming apparatus which adopts the cleaner-less electrostatic developing process, if a coloring agent, which is selected by using a specified evaluating method, is used, when a toner for electrostatic latent image development is produced by blending, into a binder resin, the coloring agent obtained by treating the surface of iron oxide with a coupling agent.

### SUMMARY OF THE INVENTION

The present invention has been completed on the basis of the knowledge as described above, an object of which is to provide a method for evaluating a coloring agent, in which the preferred coloring agent can be selected when a toner for developing an electrostatic latent image is produced by blending, into a binder resin, the coloring agent obtained by treating the surface of iron oxide with a coupling agent. Another object of the present invention is to provide the coloring agent which is selected in accordance with the evaluating method, and the toner for electrostatic latent image development which is blended with the coloring agent.

According to a first aspect of the present invention, there is provided a method for evaluating a coloring agent to be blended into a toner for electrostatic latent image development, wherein the coloring agent is formed of iron oxide to which a surface treatment is applied with a coupling agent to make a surface hydrophobic, the method comprising:
measuring pH of the coloring agent; calculating a surface coating ratio of the coloring agent with the coupling agent; determining a bulk change ratio of the coloring agent; and selecting the coloring agent which expresses that pH is 5.3 to 7.7, the surface coating ratio with the coupling agent is 26.7 to 81.6%, and the bulk change ratio is 30.9 to 50.0%.

According to a second aspect of the present invention, there is provided a coloring agent to be blended into a toner for electrostatic latent image development, the coloring agent being formed of iron oxide to which a surface treatment is applied with a coupling agent to make a surface hydrophobic, wherein pH is 5.3 to 7.7, a surface coating ratio with the coupling agent is 26.7 to 81.6%, and a bulk change ratio is 30.9 to 50.0%.

According to a third aspect of the present invention, there is provided a toner for electrostatic latent image development; comprising a coloring agent; and a binder resin; wherein the coloring agent is formed of iron oxide to which a surface treatment is applied with a coupling agent to make a surface hydrophobic, and the coloring agent expresses that pH is 5.3 to 7.7, a surface coating ratio with the coupling agent is 26.7 to 81.6%, and a bulk change ratio is 30.9 to 50.0%.

### BRIEF DESCRIPTION OF THE DRAWINGS

FIG. 1 shows schematic illustrations for explaining a method for calculating the bulk change ratio.

FIG. 2 shows a sectional view illustrating a process unit of a printer used for a transfer residue test.

### DESCRIPTION OF THE PREFERRED EMBODIMENTS

In the respective inventions as defined above, the coloring agent is composed of iron oxide to which the surface treatment is applied with the coupling agent which makes the surface to be hydrophobic.

Those usable as iron oxide include iron oxide particles such as maghemite particles, magnetite particles, and berthollide compound particles as an intermediate oxide between maghemite and magnetite. Impurities other than iron and oxygen may be contained in the iron oxide particles within a range in which the characteristics of the iron oxide particles are not inhibited. For example, Mn, Co, Ni, Cu, Mg, Zn, Ba, Sr, and Pb may be contained. The shape of the iron oxide particles may be appropriately selected, for example, from the needle shape, the cubic shape, the octahedral shape, the spherical shape, and the plate shape. The specific surface area is preferably about 1 to 30 m²/g.

Those usable as the coupling agent include, for example, coupling agents based on silane, titanium, and aluminum. In particular, the coupling agent based on silane is preferred. Those usable as the silane-based coupling agent include substances as represented by a general formula of X—Si—(OR)ₙ provided that X represents an organic functional group such as alkyl group, vinyl group, glycidoxy group, and methacrylic group, OR represents an alkoxy group such as methoxy group and ethoxy group, and n represents an integer of 1 to 3.

Specified names of the silane-based coupling agents as described above may include, for example, vinyltrichlorosilane, vinyltrimethoxysilane, 2-(3,4-epoxycyclohexyl)ethyltrimethoxysilane, γ-glycidoxypropyltriethoxysilane, p-styryltrimethoxysilane, γ-methacryloxypropyldimethoxysilane, γ-methacryloxypropyltrimethoxysilane, γ-methacryloxypropyldiethoxysilane, γ-methacryloxypropyltriethoxysilane, γ-acryloxypropyltrimethoxysilane, γ-aminopropyltrimethoxysilane, N-B(aminoethyl)-γ-aminopropyltrimethoxysilane, γ-ureidopropyltriethoxysilane, γ-chloropropyltrimethoxysilane, γ-mercaptopropyltrimethoxysilane, bis(triethoxylylpropyl)tetrasulfide, γ-isocyanatopropyltriethoxysilane, trimethoxyvinylsilane, ethyltrimethoxysilane, phenyltrimethoxysilane, hexyltrimethoxysilane, hexyltriethoxysilane, and decyltrimethoxysilane.

It is preferable that the coupling agent as described above is used in an amount of 0.5 to 5 parts by weight with respect to 100 parts by weight of the iron oxide particles as the base material. The specified surface treatment method may be considered to include the wet method and the dry method. For example, the wet method resides in such a method that iron oxide is dispersed in a dispersion medium such as water or organic solvent to form a slurry to which the coupling agent is added while performing the agitation. In the case of the wet method as described above, iron oxide can be dispersed until arrival at the primary particle level relatively easily, because iron oxide is dispersed in the liquid. Therefore, the surface treatment can be performed uniformly or homogeneously. On the other hand, for example, the dry method resides in such a method that the coupling agent itself or a preparation obtained by diluting the coupling agent with water or organic solvent is sprayed while agitating iron oxide in a high speed agitator such as a Henschel mixer. The dry method as described above is suitable for the mass production, because any excessive coagulate is not produced, which would be otherwise caused especially by the drying step. No problem arises even when the coloring agent in the present invention is treated by either the wet method or the dry method.

In the evaluating method of the present invention, the first to third tests are carried out as explained below, which are directed to the coloring agent as described above.

The first test is a test to measure pH. Specifically, for example, the following test procedure is available. That is, pH can be measured in accordance with the following procedure on the basis of the JIS K-5101-1991 26 (3.1) boiling method. At first, 5 g of the coloring agent as described above (=surface-treated iron oxide) and 100 ml of pure water are introduced into a beaker (volume: 200 ml), which are boiled for 7 minutes, followed by being cooled to room temperature. Water is evaporated from the beaker as the boiling proceeds. Therefore, in order to replenish the beaker with water in an amount corresponding to the amount of evaporation, only water is separately boiled and cooled to room temperature, and the water is added to the beaker by the amount corresponding to the amount of evaporation. The coloring agent and water, which are contained in the beaker, are sufficiently agitated to perform the measurement with pH/ION meter F-24 (produced by HORIBA, Ltd.).

The second test is a test to calculate the surface coating ratio with the coupling agent. For example, the surface coating ratio can be calculated in accordance with the following procedure. At first, the amount of addition w (g) of the coupling agent, which is required to coat one layer of the iron oxide surface, is calculated on the basis of the following numerical expression (1) from the minimum coating area a (m²/g) inherent in the coupling agent and the BET specific surface area b (m²/g) and the amount w′ (g) of iron oxide as the treatment objective.
Amount of addition of coupling agent w(g)=(w′×b)/a (1)

It is assumed that the coating ratio of 100% resides in the state in which all hydroxyl groups on the iron oxide surface are bonded to the silane coupling agent when the treatment is performed with the amount of addition w to theoretically coat one layer on the iron oxide surface. The total carbon amount is measured by the carbon elementary analysis directed to the iron oxide after the treatment. An obtained measured value is prescribed to correspond to the total carbon amount of the case in which the coating ratio is 100%.

Subsequently, the treated iron oxide is washed with organic solvent, and thus the coupling agent, which is not chemically bonded, is removed. The iron oxide, which is obtained after the washing and the drying, is subjected to the carbon elementary analysis again to measure the total carbon amount. It is considered that an obtained measured value corresponds to the total carbon amount originating from the chemically bonded coupling agent.

Therefore, the surface coating ratio, which is brought about by the coupling agent chemically adsorbed to the iron oxide surface, can be calculated from the measured values.

The third test resides in a test to determine the bulk change ratio. For example, the bulk change ratio can be calculated in accordance with the following procedure. At first, 3 ml of distilled water is introduced into a cylindrical vessel having a diameter of 10 mm beforehand. A dispersion liquid is prepared by dispersing 1 part by weight of the coloring agent described above (=surface-treated iron oxide) in 3 parts by weight of styrene monomer. 3 ml of the dispersion liquid is stationarily poured from a bottom portion of the cylindrical vessel described above. Accordingly, a second layer, which includes the styrene monomer and the coloring agent as major components, is formed under a first layer which includes distilled water as a major component. Therefore, the height a of the second layer is measured immediately after the pouring. When the cylindrical vessel is left to stand stationarily for 60 minutes after the pouring, then a part of the styrene monomer is separated from the second layer, and a third layer, which includes the styrene monomer as a major component, is formed over the first layer. Therefore, the height b of the second layer is measured after the passage of 60 minutes from the pouring. The bulk change ratio c is calculated on the basis of the following numerical expression (2) on the basis of the heights a, b.
Bulk change ratio c(%)=(1−b/a)×100 (2)

After carrying out the three types of tests as described above, the coloring agent is selected on the basis of the test results, which expresses that pH is 5.3 to 7.7, the surface coating ratio with the coupling agent is 26.7 to 81.6%, and the bulk change ratio is 30.9 to 50.0%.

It is considered that pH of the coloring agent is changed depending on the amount of adsorption (coating ratio) of the coupling agent on the iron oxide surface and the functional group of the coupling agent. If the bonding of the coupling agent is inadequate, it is presumed that pH of the coloring agent exhibits any inadequate value outside the numerical value range as described above, for example, due to the influence of the unreacted alkoxy group, hydroxyl group, and silanol group. If pH of the coloring agent is not within the numerical value range as described above, a tendency appears such that the dispersibility of the coloring agent is deteriorated. For example, in the case of the pulverization method, it is feared that the dispersibility may be deteriorated in a binder resin in a semi-melted state in the kneading step for materials. In the case of the suspension polymerization method, it is feared that the dispersion stability of the dispersion liquid may be deteriorated.

It is considered that the surface coating ratio with the coupling agent indicates the amount of the coupling agent bonded to the iron oxide surface by the chemical adsorption or the strong physical adsorption. In this case, the parameter, which indicates the amount of the coupling agent, may be also assumed to include, for example, the blending amount (blending ratio) of the coupling agent. However, the blending amount also includes those resulting from the coupling agent which is not bonded to the iron oxide surface and the coupling agent which exists in a form to be removed by the washing with organic solvent. Therefore, such a form of the coupling agent is exfoliated from the iron oxide during the production of the toner, even if the coupling agent exists in the vicinity of the iron oxide surface. In view of this fact, the surface coating ratio as described above is considered to reflect the amount of the coupling agent which is bonded to the iron oxide surface by the chemical adsorption or the strong physical adsorption. Therefore, the surface coating ratio is considered to be effective in order to evaluate the substantial effect to modify the surface. If the surface coating ratio is less than 26.7%, the amount of the coupling agent bonded to the iron oxide surface by the chemical adsorption or the strong physical adsorption is too small. Therefore, the effect to modify the surface, which is brought about by the coupling agent, is insufficient. The hydrophobicity is deteriorated, and the dispersibility into the binder resin is deteriorated. On the other hand, if the surface coating ratio exceeds 81.6%, the amount of the coupling agent bonded to the iron oxide surface by the chemical adsorption or the strong physical adsorption is too large. Therefore, it is considered that a tendency appears such that the iron oxide is coated with the coupling agent in a multiple form to form a multilayer structure. The probability of existence is increased for any excessive alkoxy group and any hydrolyzed hydroxyl group. It is considered that these factors exert any harmful influence on the dispersibility of the coloring agent.

Further, the bulk change ratio is an index to select those in which the conformability of the coloring agent to the organic material and the high dispersibility are well-balanced. When the amount of separation of the styrene monomer is large, then the third layer is thickened, and the second layer is thinned corresponding thereto. Therefore, in this case, the bulk change ratio is increased, which means the fact that the conformability is unsatisfactory between the coloring agent and the styrene monomer. If the bulk change ratio exceeds 50.0%, a tendency appears such that the conformability between the coloring agent and the styrene monomer is excessively deteriorated, which is not desirable. On the other hand, if the amount of separation of the styrene monomer is small, then the third layer is thinned, and the second layer is thickened corresponding thereto. Therefore, in this case, the bulk change ratio is decreased, which means the fact that the iron oxide forms coagulates in the styrene monomer, the bulk volume of iron oxide is increased, and the monomer is retained in the coagulates. If the bulk change ratio is lower than 30.9%, a tendency appears such that the dispersibility of iron oxide is excessively decreased in the organic material, which is not desirable. In other words, when those in which the bulk change ratio is excessively large or excessively small are excluded, it is possible to select the coloring agent in which the satisfactory conformability to the organic material and the high dispersibility are well-balanced. As a result, it is presumed that when a toner is produced, it is possible to obtain the toner which is satisfactory in the chargeability and the fluidity.

The coloring agent, which is selected in accordance with the evaluating method as described above, corresponds to the coloring agent of the present invention.

Further, the toner for electrostatic latent image development, which is obtained by blending the coloring agent, corresponds to the toner for electrostatic latent image development of the present invention. However, when the toner for electrostatic latent image development of the present invention is produced, no problem arises even when another coloring agent is subsidiarily added in a small amount in addition to the coloring agent of the present invention, within a range in which the characteristics, which are brought about by the coloring agent of the present invention, are not inhibited. Those usable as the another coloring agent include, for example, carbon black, other pigments, and other dyes.

The method for producing the toner for electrostatic latent image development can arbitrarily adopt known methods which are utilized when particles of the toner for electrostatic latent image development of this type (hereinafter referred to as “toner particles”) are produced. For example, the toner may be produced by a pulverization method in which a binder resin and a coloring agent (and other additives or the like, if necessary) are melted and kneaded, followed by being pulverized and classified after the cooling so that a desired particle size distribution is obtained. Alternatively, the toner may be produced by the polymerization method in which a polymerizable monomer preparation containing a polymerizable monomer to serve as a raw material for a binder resin and a coloring agent (and other additives, if necessary) is polymerized in an appropriate aqueous medium. In order to obtain a toner which provides a satisfactory image quality even on the regenerated paper, it is preferable to use those produced by the polymerization method. The production, which is based on the polymerization method, is usually carried out, for example, in accordance with the suspension polymerization method, the emulsion polymerization method, the dispersion polymerization method, and the melting suspension method (emulsifying dispersion method).

The toner particles may have a capsule structure obtained by combining different polymers, such as the capsule structure and the core-shell structure. The toner particles having the capsule structure (hereinafter sometimes referred to as “capsule toner”) may be either those obtained by the pulverization method or those obtained by the polymerization method.

As for the particle size of the toner particles, the volume average particle size (dv) is 3 to 12 μm and preferably 4 to 10 μm, and the ratio (dv/dn) between the volume average particle size and the number average particle size (dn) is within a range of 1 to 1.3.

Specified examples of the binder resin which can be used when the toner particles are produced include, for example, resins which have been hitherto widely used for the toner, including, for example, polymers of styrene and substituted derivatives thereof such as polystyrene, poly-p-chlorostyrene, and polyvinyltoluene; styrene copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene butyl acrylate copolymer, styrene-octyl acrylate copolymer, styrene-methyl methacrylate copolymer, styrene ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl ethyl ether copolymer, styrene vinyl methyl ketone copolymer, styrene-butadiene copolymer, styrene-isoprene copolymer, styrene-acrylonitrile-indene copolymer, styrene-maleic acid copolymer, and styrene-maleic ester copolymer; polymethylmethacrylate, polyvinyl chloride, polyvinyl acetate, polyethylene, polypropylene, polyester, polyurethane, polyamide, epoxy resin, polyvinylbutylal, polyacrylic acid resin, rosin, modified rosin, terpene resin, phenol resin, aliphatic or alicyclic hydrocarbon resin, aromatic petroleum resin, and chlorinated paraffin. These compounds may be used singly or in a mixed manner.

Preferred polymerizable monomers, which are usable to produce the toner particles by the polymerization method, may include monovinylic monomers. Specifically, the monomer is exemplified by monovinylic monomers including, for example, styrenic monomers such as styrene, vinyltoluene, and α-methylstyrene; acrylic acid, methacrylic acid; acrylic acid or methacrylic acid derivatives such as methyl acrylate, ethyl acrylate, propyl acrylate, butyl acrylate, 2-ethylhexyl acrylate, cyclohexyl acrylate, isobonyl acrylate, cyclohexyl methacrylate, isobonyl methacrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylamide, and methacrylamide; monoolefinic monomers such as ethylene, propylene, and butylene; vinyl esters such as vinyl acetate and vinyl propionate; vinyl ethers such as vinyl methyl ether and vinyl ethyl ether; vinyl ketones such as vinyl methyl ketone and methyl isopropyl ketone; and nitrogen-containing vinyl compounds such as 2-vinylpyridine, 4-vinylpyridine, and N-vinylpyrrolidone. The monovinylic monomers may be used singly, or a plurality of the monomers may be used in combination. Those preferably usable as the monovinylic monomers as described above include, for example, styrenic monomers and combinations of styrenic monomers and acrylic acid or methacrylic acid derivatives.

When the toner particles are produced by the polymerization method, it is effective for the improvement in the hot offset to use a cross-linkable compound such as cross-linkable monomers and cross-linkable polymers together with the polymerizable monomer. The cross-linkable monomer is a monomer having two or more polymerizable carbon-carbon unsaturated double bonds. Specifically, the cross-linkable monomer may include, for example, aromatic divinyl compounds such as divinylbenzene, divinylnaphthalene, and derivatives thereof; diethylenic unsaturated carboxylic acid esters such as ethylene glycol dimethacrylate and diethylene glycol dimethacrylate; (meth)acrylates originating from aliphatic compounds with alcohols at both ends such as 1,4-butanediol and 1,9-nonanediol; divinyl compounds such as N,N-divinylaniline and divinyl ether; and compounds having three or more vinyl groups. The cross-linkable polymer may include, for example, (meth)acrylates originating from polysiloxane, polyester, and polypropylene and polyethylene having two or more hydroxyl groups in the molecule. The cross-linkable monomers and the cross-linkable polymers as described above may be used singly respectively, or two or more of them may be used in combination. The amount of use is usually not more than 10 parts by weight and preferably 0.1 to 2 parts by weight per 100 parts by weight of the polymerizable monomer. The polymerizable monomer and the cross-linkable compound as described above are polymerized to provide the binder resin.

The polymerization initiator, which is usable to produce the toner particles by the polymerization method, may be exemplified, for example, by persulfates such as potassium persulfate and ammonium persulfate; azo compounds such as 4,4′-azobis(4-cyanovaleric acid), 2,2′-azobis(2-amidinopropane) dibasic acid salt, 2,2′-azobis-2-methyl-N-1,1′-bis(hydroxymethyl)-2-hydroxyethylpropioamide, 2,2′-azobis(2,4-dimethylvaleronitrile), 2,2′-azobisisobutylnitrile, and 1,1′-azobis(1-cyclohexanecarbonitrile); and peroxides such as methyl ethyl peroxide, di-t-butyl peroxide, acetyl peroxide, dicumyl peroxide, lauroyl peroxide, benzoyl peroxide, t-butylperoxy-2-ethylhexanoate, t-butyl perbutyl neodecanoate, t-hexylperoxy-2-ethyl hexanoate, t-butylperoxy pivalate, t-hexylperoxy pivalate, di-isopropylperoxy dicarbonate, di-t-butylperoxy isophthalate, 1,1′,3,3′-tetramethylbutylperoxy-2-ethyl hexanoate, and t-butylperoxy isobutylate. Further, the polymerization initiator may include redox initiators obtained by combining the polymerization initiators as described above and reducing agents.

In particular, it is especially preferable to select an oil-soluble polymerization initiator which is soluble in the polymerizable monomer to be used. If necessary, a water-soluble polymerization initiator may be used in combination therewith. The polymerization initiator as described above is used in an amount of 0.1 to 20 parts by weight, preferably 0.3 to 15 parts by weight, and more preferably 0.5 to 10 parts by weight with respect to 100 parts by weight of the polymerizable monomer. The polymerization initiator can be previously added into the polymerizable monomer composition. In some cases, the polymerization initiator can be also added to a suspension after the completion of the granulation step.

Further, a mold release agent and a charge control agent can be added as additives other than the above, in order to improve the performance of the toner. Further, it is also possible to add, for example, a molecular weight-adjusting agent when the production is carried out by the polymerization method.

The mold release agent is exemplified, for example, by one or two or more species of low molecular weight polyolefin waxes such as low molecular weight polyethylene, low molecular weight polypropylene, and low molecular weight polybutylene; terminal-modified polyolefin waxes such as molecular terminal-oxidized low molecular weight polypropylene, low molecular weight terminal-modified polypropylene with the molecular terminal substituted with epoxy group, block polymer thereof together with low molecular weight polyethylene, molecular terminal-oxidized low molecular weight polyethylene, low molecular weight polyethylene with the molecular terminal substituted with epoxy group, and block polymer thereof together with low molecular weight polypropylene; plant-based natural waxes such as candelilla, carnauba, rice, Japan tallow, and jojoba; petroleum-based waxes and modified waxes thereof such as paraffin, microcrystalline, and petrolactam; mineral-based waxes such as montan, ceresin, and ozokerite; synthetic waxes such as Fisher-Tropsch wax; multifunctional ester compounds such as pentaerythritol tetramyristate, pentaerythritol tetrapalmitate, and dipentaerythritol hexamyristate; and aromatic polyvalent carboxylic acid ester compounds (with a number of carbon atoms of alkyl portion of not less than 15) such as phthalic distearyl, phthalic dibehenyl, isophthalic distearyl, isophthalic dibehenyl, and trimellitic distearyl monobehenyl. One of the compounds as described above is used singly, or two or more of the compounds as described above are used in a mixed manner.

The charge control agent is preferably contained in the toner particles in order to improve the chargeability of the toner. A variety of charge control agents can be used as the charge control agent. Those usable as the charge control agent may include charge control agents such as Bontron N01 (produced by Orient Chemical Industries, Ltd.), Bontron NO₄ (produced by Orient Chemical Industries, Ltd.), Bontron N07 (produced by Orient Chemical Industries, Ltd.), Nigrosine Base EX (produced by Orient Chemical Industries, Ltd.), Spiron Black TP415 (produced by Hodogaya Chemical), Spiron Black TP302 (produced by Hodogaya Chemical), Spiron Black TRH (produced by Hodogaya Chemical), T-77 (produced by Hodogaya Chemical), Bontron S-34 (produced by Orient Chemical Industries, Ltd.), Bontron E-81 (produced by Orient Chemical Industries, Ltd.), Bontron E-84 (produced by Orient Chemical Industries, Ltd.), Bontron E-89 (produced by Orient Chemical Industries, Ltd.), Bontron F-21 (produced by Orient Chemical Industries, Ltd.), COPY CHARGE NX (produced by Clariant), COPY CHARGE NEG (produced by Clariant), COPY BLUE PR (produced by Clariant), TNS-4-1 (produced by Hodogaya Chemical), TNS-4-2 (produced by Hodogaya Chemical), LR-147 (produced by Carlit Japan), FCA-201 (produced by Fujikurakasei Co., Ltd.), and FCA-1001 (produced by Fujikurakasei Co., Ltd.); and charge control agents (charge control resins) such as quaternary ammonium (salt) group-containing copolymers described, for example, in Japanese Patent Application Laid-open Nos. 11-15192, 3-175456, and 3-243954 and sulfonic acid (salt) group-containing copolymers described, for example, in Japanese Patent Application Laid-open Nos. 3-243954, 1-217464 (corresponding to U.S. Pat. No. 4,950,575), and 3-15858. The charge control resin is preferred in that the compatibility is high with respect to the binder resin, and it is possible to obtain the toner which has the stable chargeability even in the case of the continuous printing operation at a high speed. The charge control agent is usually used at a ratio of 0.01 to 10 parts by weight and preferably 0.1 to 7 parts by weight with respect to 100 parts by weight of the binder resin or the polymerizable monomer.

When the toner particles are produced by the suspension polymerization method, it is preferable to use a dispersion stabilizer. Specified examples of the dispersion stabilizer may include, for example, sulfates such as barium sulfate and calcium sulfate; carbonates such as barium carbonate, calcium carbonate, and magnesium carbonate; phosphates such as calcium phosphate, metal oxides such as aluminum oxide and titanium oxide (metal compounds); metal hydroxides such as aluminum hydroxide, magnesium hydroxide, and ferric hydroxide; water-soluble high molecular weight compounds such as polyvinyl alcohol, methyl cellulose, and gelatin; and surfactants such as anionic surfactants, nonionic surfactants, and ampholytic surfactants. Among them, the dispersion stabilizer, which contains colloid of metal compound, especially hardly water-soluble metal hydroxide, makes it possible to narrow the particle size distribution of polymer particles, wherein the vividness of the image is improved. Therefore, such a dispersion stabilizer is preferred.

The dispersion stabilizer, which contains the colloid of the hardly water-soluble metal hydroxide, is not limited in relation to the production method. However, it is preferable to use a colloid of hardly water-soluble metal hydroxide obtained by adjusting pH of an aqueous solution of a water-soluble polyvalent metal salt compound to be not less than 7, especially a colloid of hardly water-soluble metal hydroxide produced by a reaction in aqueous phase between a water-soluble polyvalent metal salt compound and an alkali metal hydroxide salt.

As for the colloid of hardly water-soluble metal hydroxide, it is preferable that the number particle size distribution D50 (50% accumulated value of number particle size distribution) is not more than 0.5 μm, and D90 (90% accumulated value of number particle size distribution) is not more than 1 μm. If the particle size of the colloid is increased, then the stability of polymerization is collapsed, and the storage performance of the toner is deteriorated.

The dispersion stabilizer is usually used at a ratio of 0.1 to 20 parts by weight with respect to 100 parts by weight of the polymerizable monomer. If the ratio is too low, then it is difficult to disperse liquid droplets of the polymerizable monomer composition sufficiently stably, and coagulates of polymer particles tend to be produced. On the other hand, if the ratio is too high, then the viscosity of the aqueous dispersion medium is increased, the particle size distribution of the polymerized toner is widened, and hence the yield is lowered.

It is preferable that amorphous silica fine particles (hereinafter referred to as “silica”) are adhered as an external additive to the toner particles as explained above. When the silica is used as the external additive, it is possible to obtain the toner which provides a satisfactory image quality even on the regenerated paper. The amount of the external additive is not specifically limited. However, the amount of the external additive is usually 0.05 to 10 parts by weight and preferably 0.1 to 6 parts by weight with respect to 100 parts by weight of the toner particles.

It is desirable for the silica that the content of metal impurities other than silicon is not more than 1.0 ppm and preferably not more than 0.5 ppm. If the metal impurity content of the silica is large, then the charge amount is lowered to a great extent at a high temperature and a high humidity, and it is feared that a problem arises such that the fog occurs with ease. It is desirable for the silica that the specific surface area is 5 to 300 m²/g and preferably 10 to 250 m²/g. Several types of those having different sizes may be combined for the silica. For example, it is also allowable that the silica having a specific surface area of 10 to 100 m²/g is combined with the silica having a specific surface area of 100 to 250 m²/g. If the specific surface area is too small, a problem tends to arise such that the blur occurs at a low temperature and a low humidity when the printing is performed on the regenerated paper. If the specific surface area is too large, a problem tends to arise such that the filming occurs.

The silica as described above is obtained, for example, as follows. That is, high purity alkoxysilane is heated and evaporated, followed by being introduced into an oxyhydrogen flame burner by being carried by an inert gas flow (for example, nitrogen gas or argon gas) so that the combustion and the decomposition are caused in a flame in which inflammable gases such as hydrogen gas, oxygen gas, nitrogen gas, and methane gas exist. The specific surface area can be controlled by changing, for example, the type of alkoxysilane, the types of various gases to be used in this step, and the ratios of use thereof.

The alkoxysilane as described above may include methyltrimethoxysilane, tetramethoxysilane, ethyltrimethoxysilane, n-propyltriethoxysilane, methyltributoxysilane, diethyldipropoxysilane, and trimethylbutoxysilane. The silica can be also produced by using oligomers and polymers of alkoxysilanes as described above. The method, by which alkoxysilane is purified to have a high purity, is not specifically limited. However, it is preferable to adopt any general technique such as the distillation.

It is also allowable that the silica as described above may be those having been subjected to the hydrophobicity-conferring treatment, for example, with a silane coupling agent or a silicone oil. It is preferable that the silica, which has been subjected to the hydrophobicity-conferring treatment, has a degree of hydrophobicity of 30 to 90% as measured by the methanol method.

It is also possible to use organic or inorganic fine particles which are generally used as the external additive for the toner other than the silica as described above. The organic fine particles include, for example, methacrylic ester polymer particles, acrylic ester polymer particles, styrene-methacrylic ester copolymer particles, styrene-acrylic ester copolymer particles, zinc stearate, calcium stearate, and core-shell type particles with cores formed of methacrylic ester copolymer and shells formed of styrene polymer. Those also usable as the inorganic fine particles other than the silica include, for example, silicon oxide, aluminum oxide, zinc oxide, tin oxide, titanium oxide, barium titanate, and strontium titanate. It is desirable that the fine particles other than the silica as described above are used in combination within a range of not more than 50% by weight and preferably not more than 45% by weight with respect to the total amount of the external additive.

When the toner particles as explained above are produced, if the toner for electrostatic latent image development, which is produced by blending the coloring agent selected by the evaluating method as described above, is utilized, then no failure arises in the transfer to the recording medium even in the case of the image-forming apparatus which adopts the cleaner-less electrostatic development process, and it is possible to improve the quality of the image to be recorded on the recording medium.

This effect has been confirmed by the inventors by carrying out the respective tests as described above directed to a plurality of coloring agent samples to determine pH, the surface coating ratio, and the bulk change ratio of each of the samples, blending the coloring agent samples to manufacture toner samples, and measuring the degree of the transfer failure. The reason, why the transfer failure can be suppressed, has not been clearly elucidated yet.

However, the following speculation may be made. That is, when the coloring agent, which satisfies the conditions as described above, is used, then it is possible to improve, for example, the dispersibility of the coloring agent in the toner and the balance of the state of existing together with the other constitutive materials for the toner, and it is possible to improve the chargeability and the fluidity of the toner. As a result, it is possible to obtain the toner with which the transfer failure is hardly caused in the transfer step.

As explained above, according to the present invention, it is possible to provide the method for evaluating the coloring agent, which makes it possible to select the preferred coloring agent when the toner for electrostatic latent image development is produced such that the coloring agent, which is obtained by treating the iron oxide surface with the coupling agent, is blended into the binder resin. Further, it is possible to provide the coloring agent which is selected in accordance with the evaluating method, and the toner for electrostatic latent image development which is blended with the coloring agent.

### EXAMPLES

Next, embodiments of the present invention will be explained by way of example.

(1) Method for Producing Coloring Agent

At first, preparations of Coloring agents 1 to 21 used in Examples and Comparative Examples are shown in Table 1. Iron oxide, which was used herein, was MTS206 (produced by Toda Kogyo Corp.) in which the mean particle size was 0.22 μm, and the BET specific surface area was 8.8 m²/g. In Table 1 shown below, 50 g of iron oxide was treated for only Coloring agent 12, but 100 g of iron oxide was treated for those other than Coloring agent 12. Treatment amounts of coupling agents with respect to iron oxide were as shown in Table 1 below for Coloring agents 1 to 21 respectively. The following method was adopted as the coupling treatment method. That is, a solution, which was obtained by diluting the coupling agent with 10% alcohol aqueous solution, was prepared. The obtained coupling agent solution was added while agitating iron oxide in a mixer.

TABLE 1

| | | Coupling agent | | |
|---|---|---|---|---|
| | Iron oxide | | Minimum | Blending |
| | Blending | | coating | amount |
| | amount (g) | Substance | area (m²/g) | (g) |
| Coloring agent 1 | 100 | *1 | 300 | 2.53 |
| Coloring agent 2 | 100 | *1 | 300 | 2.90 |
| Coloring agent 3 | 100 | *2 | 270 | 4.22 |
| Coloring agent 4 | 100 | *2 | 270 | 1.69 |
| Coloring agent 5 | 100 | *2 | 270 | 2.81 |
| Coloring agent 6 | 100 | *2 | 270 | 3.0 |
| Coloring agent 7 | 100 | *3 | 302 | 1.61 |
| Coloring agent 8 | 100 | *4 | 380 | 0.7 |
| Coloring agent 9 | 100 | *5 | 314 | 2.41 |
| Coloring agent 10 | 100 | *5 | 314 | 0.92 |
| Coloring agent 11 | 100 | *6 | 314 | 2.42 |
| Coloring agent 12 | 50 | *7 | 335 | 1.35 |
| Coloring agent 13 | 100 | *7 | 335 | 2.5 |
| Coloring agent 14 | 100 | *7 | 335 | 2.27 |
| Coloring agent 15 | 100 | *8 | 516 | 2.09 |
| Coloring agent 16 | 100 | *9 | 510 | 2.79 |
| Coloring agent 17 | 100 | *4 | 380 | 2.0 |
| Coloring agent 18 | 100 | *4 | 380 | 1.35 |
| Coloring agent 19 | 100 | *10 | 436 | 2.1 |
| Coloring agent 20 | 100 | *11 | 351 | 2.5 |
| Coloring agent 21 | 100 | *12 | 396 | 1.28 |

*1: γ-methacryloxypropyldiethoxysilane;
*2: γ-methacryloxypropyltriethoxysilane;
*3: decyltrimethoxysilane;
*4: hexyltrimethoxysilane;
*5: hexyltriethoxysilane;
*6: γ-methacryloxypropyltrimethoxysilane;
*7: γ-methacryloxypropyldimethoxysilane;
*8: trimethoxyvinylsilane;
*9: ethyltrimethoxysilane;
*10: γ-aminopropyltrimethoxysilane;
*11: N-B(aminoethyl) γ-aminopropyltrimethoxysilane;
*12: phenyltrimethoxysilane.

Coloring agents 1 to 21 shown in Table 1 above were produced in accordance with the following procedure.

The amounts of iron oxide and the coupling agent used to produce each of Coloring agents 1 to 21 are as shown in Table 1 above. At first, the coupling agent is added to 10% aqueous alcohol solution, followed by being mixed until the coupling agent is completely dispersed (dissolved). Thus, a coupling agent solution is obtained. The amount of the aqueous alcohol solution used in this procedure was 2 to 5 times the amount of the coupling agent.

The iron oxide particles (magnetite particles) are introduced into a mixer (Henschel mixer or Super mixer), and small amounts of the coupling agent solution are added stepwise while homogeneously agitating the iron oxide particles. After the total amount of the coupling agent solution is added, the agitation and the mixing are performed for further 5 to 10 minutes.

After the completion of the mixing, the wet iron oxide particles were taken out, and they are uniformly spread on a shallow tray. The iron oxide particles are dried for 1 hour at 100° C. to 150° C. After the drying, clod portions are sufficiently loosened, and thus the expected coloring agent particles are obtained.

(2) Method for Evaluating Coloring Agent

Coloring agents 1 to 21 were evaluated in accordance with the following three types of tests.

pH Measuring Test

The pH measuring test was carried out in accordance with the following procedure on the basis of the JIS K-5101-1991 26(3.1) boiling method.

At first, 5 g of each of the coloring agents as described above and 100 ml of pure water were introduced into a beaker (volume: 200 ml), which were boiled for 7 minutes, followed by being cooled to room temperature. Water was evaporated from the beaker in accordance with the boiling. Therefore, in order to replenish the beaker with water in an amount corresponding to the amount of evaporation, only water was separately boiled and cooled to room temperature, and the water was added to the beaker by the amount corresponding to the amount of evaporation. The coloring agent and water, which were contained in the beaker, were sufficiently agitated to measure pH with pH/ION meter F-24 (produced by HORIBA, Ltd.).

Calculation of Surface Coating Ratio

The amount of addition of the coupling agent w(g)=(w′×b)/a (g), which was required to coat one layer of the iron oxide surface, was calculated from the minimum coating area a (m²/g) inherent in the coupling agent and the BET specific surface area b (m²/g) and the amount w′ (g) of iron oxide as the treatment objective, and the surface treatment was performed.

The total carbon amount was measured by the carbon elementary analysis directed to the objective of iron oxide after the treatment. The measured value is prescribed to correspond to the total carbon amount of the case in which the coating ratio is 100%.

Subsequently, the treated iron oxide was washed with organic solvent, and thus the coupling agent, which was not chemically bonded, was removed. The iron oxide, which was obtained after the washing and the drying, was subjected to the carbon elementary analysis again to measure the total carbon amount. It is considered that the measured value corresponds to the total carbon amount originating from the chemically bonded coupling agent.

The surface coating ratio, which was brought about by the coupling agent chemically adsorbed to the iron oxide surface, was calculated from the measured values.

Calculation of Bulk Change Ratio

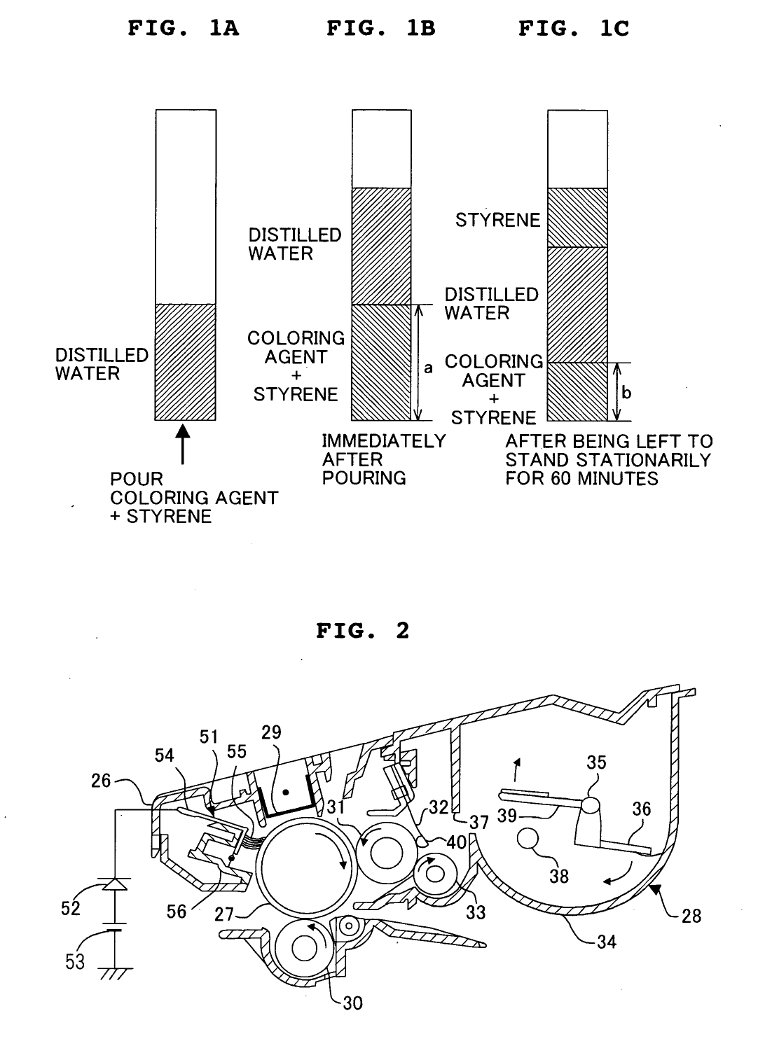

At first, as shown in FIG. 1A, 3 ml of distilled water is introduced into a cylindrical vessel having a diameter of 10 mm beforehand. A dispersion liquid is prepared by dispersing 1 part by weight of the coloring agent described above in 3 parts by weight of styrene monomer. 3 ml of the dispersion liquid is stationarily poured from a bottom portion of the cylindrical vessel described above. Accordingly, as shown in FIG. 1B, a second layer, which includes the styrene monomer and the coloring agent as major components, is formed under a first layer which includes distilled water as a major component. Therefore, the height a of the second layer is measured immediately after the pouring. When the cylindrical vessel is left to stand stationarily for 60 minutes after the pouring, then a part of the styrene monomer is separated from the second layer, and a third layer, which includes the styrene monomer as a major component, is formed over the first layer as shown in FIG. 1C. Therefore, the height b of the second layer is measured after the passage of 60 minutes from the pouring. The bulk change ratio c=(1−b/a)×100 is calculated on the basis of the heights a, b.

When the amount of separation of the styrene monomer is large, then the third layer is thickened, and the second layer is thinned corresponding thereto. This means the fact that the conformability is unsatisfactory between the coloring agent and the styrene monomer. On the other hand, if the amount of separation of the styrene monomer is small, then the third layer is thinned, and the second layer is thickened corresponding thereto. This means the following fact. That is, the iron oxide forms coagulates in the styrene monomer, and hence the bulk volume of iron oxide is increased. Further, the monomer is retained in the coagulates. This indicates the fact that the dispersibility of iron oxide is unsatisfactory in the organic material. Therefore, when those in which the bulk change ratio is excessively large or excessively small are excluded, it is possible to select the coloring agent in which the satisfactory conformability to the organic material and the high dispersibility are well-balanced. As a result, it is considered that when a toner is produced, it is possible to obtain the toner which is satisfactory in the chargeability and the fluidity.

Results of the three types of the tests described above are shown in Table 2 below.

TABLE 2

| | | Coating ratio | Bulk change |
|---|---|---|---|
| | pH | (%) | ratio (%) |
| Coloring agent 1 | 7.0 | 81.6 | 42.9 |
| Coloring agent 2 | 7.7 | 30.0 | 30.9 |
| Coloring agent 3 | 7.5 | 42.9 | 35.7 |
| Coloring agent 4 | 7.5 | 59.6 | 37.0 |
| Coloring agent 5 | 6.7 | 79.3 | 32.7 |
| Coloring agent 6 | 6.5 | 41.7 | 39.3 |
| Coloring agent 7 | 7.4 | 53.8 | 50.0 |
| Coloring agent 8 | 5.9 | 37.8 | 36.8 |
| Coloring agent 9 | 5.3 | 62.2 | 39.3 |
| Coloring agent 10 | 5.3 | 26.7 | 48.1 |
| Coloring agent 11 | 5.9 | 94.9 | 42.9 |
| Coloring agent 12 | 7.1 | 21.9 | 10.0 |
| Coloring agent 13 | 7.4 | 33.3 | 25.9 |
| Coloring agent 14 | 6.7 | 88.5 | 42.9 |
| Coloring agent 15 | 6.4 | 43.5 | 21.7 |
| Coloring agent 16 | 8.2 | 37.2 | 26.9 |
| Coloring agent 17 | 5.0 | 72.9 | 50.9 |
| Coloring agent 18 | 6.5 | 59.7 | 53.8 |
| Coloring agent 19 | 9.9 | 100.0 | 10.0 |
| Coloring agent 20 | 9.7 | 100.0 | 0 |
| Coloring agent 21 | 8.4 | 56.5 | 48.1 |

In Table 2 shown above, the results, which are directed to the selection objectives based on the method for evaluating the coloring agent according to the present invention, are obtained for Coloring agents 1 to 10, and they correspond to Examples of the coloring agent of the present invention. On the other hand, the results, which are directed to the selection objectives based on the method for evaluating the coloring agent according to the present invention, are not obtained for Coloring agents 11 to 21, and they correspond to Comparative Examples.

(3) Method for Producing Toner for Electrostatic Latent Image Development

Toners 1 to 22 were produced by using Coloring agents 1 to 21 described above. Table 3 shows the corresponding relationship between Toners 1 to 22 and Coloring agents 1 to 21 respectively and the blending amounts of the coloring agents.

TABLE 3

| | | Blending amount of |
|---|---|---|
| | Coloring agent used | Coloring agent (wt %) |
| Toner 1 | Coloring agent 1 | 25 |
| Toner 2 | Coloring agent 2 | 30 |
| Toner 3 | Coloring agent 3 | 35 |
| Toner 4 | Coloring agent 4 | 35 |
| Toner 5 | Coloring agent 5 | 35 |
| Toner 6 | Coloring agent 5 | 25 |
| Toner 7 | Coloring agent 6 | 25 |
| Toner 8 | Coloring agent 7 | 35 |
| Toner 9 | Coloring agent 8 | 35 |
| Toner 10 | Coloring agent 9 | 35 |
| Toner 11 | Coloring agent 10 | 35 |
| Toner 12 | Coloring agent 11 | 35 |
| Toner 13 | Coloring agent 12 | 35 |
| Toner 14 | Coloring agent 13 | 25 |
| Toner 15 | Coloring agent 14 | 25 |
| Toner 16 | Coloring agent 15 | 35 |
| Toner 17 | Coloring agent 16 | 35 |
| Toner 18 | Coloring agent 17 | 35 |
| Toner 19 | Coloring agent 18 | 35 |
| Toner 20 | Coloring agent 19 | 35 |
| Toner 21 | Coloring agent 20 | 35 |
| Toner 22 | Coloring agent 21 | 35 |

Toners 1 to 22 described above were produced in accordance with the following procedure.

At first, any one of Coloring agents 1 to 21 described above was dispersed together with 80 parts by weight of styrene, 20 parts by weight of n-butyl acrylate, 0.5 part by weight of a charge control agent (trade name: Spiron Black TP-415 produced by Hodogaya Chemical), 0.6 part by weight of divinylbenzene, 1 part by weight of t-dodecylmercaptan, and 2 parts by weight of Sasol Wax (trade name: PARAFLINT SPRAY 30 produced by Sasol) at room temperature with a bead mill to obtain a homogeneous mixture liquid. 5 parts by weight of a polymerization initiator (trade name: Perbutyl O produced by NOF Corporation) while agitating the mixture liquid. The agitation was continued until liquid droplets were uniform to obtain a polymerizable monomer composition.

The polymerizable monomer composition was introduced into water, followed by being highly sheared and agitated at a number of revolutions of 12,000 rpm by using TK Homomixer to granulate liquid droplets of the polymerizable monomer mixture. An aqueous dispersion of the granulated polymerizable monomer mixture was introduced into a reaction vessel equipped with mixing impellers to start the polymerization reaction at 90° C. The polymerization was performed for 8 hours, followed by being cooled to obtain an aqueous dispersion of polymer particles.

The acid washing was performed by allowing pH of the system to be not more than 4 with sulfuric acid, while agitating the aqueous dispersion of the polymer particles obtained as described above. Water was separated by the filtration. After that, 500 parts by weight of ion exchange water was newly added to form a slurry again, and the water washing was performed. After that, the dehydration and the water washing were repeatedly performed several times. The solid content was separated by the filtration, followed by being dried for 2 days at 45° C. by using a drying machine.

100 parts by weight of the dried material was mixed with silica (trade name: HDK-H2050EP produced by Wacker-Chemie GmbH, BET specific surface area: 110 m²/g); and silica (trade name: NA50H produced by Aerosil Japan, BET specific surface area: 35 m²/g), followed by being mixed at a number of revolutions of 1,400 rpm for 10 minutes by using Henschel mixer. Thus, Toners 1 to 22, each of which had a mean particle size of 10 μm, were obtained.

(4) Transfer Residue Test

The transfer residue test was carried out by using Toners 1 to 22 described above.

A printer (HL-1240 produced by Brother Industries, Ltd.) was used for the transfer residue test. As shown in FIG. 2, a process unit, which is provided for the printer, includes, for example, a photosensitive drum 27, a development cartridge 28, a scorotron type charger 29, a transfer roller 30, and a conductive brush 51 as a paper dust-removing means in a drum cartridge 26 which is detachably installed to a main body casing.

The development cartridge 28 is detachably installed to the drum cartridge 26, which includes, for example, a development roller 31, a layer thickness-regulating blade 32, a supply roller 33, and a toner box 34.

The toner, which is contained in the toner box 34, is agitated by an agitator 36 which is supported by a rotary shaft 35 provided at the center of the toner box 34, and the toner is discharged from a toner supply port 37 which is open at a side portion of the toner box 34. A window 38, which is usable to detect the remaining amount of the toner, is provided on the side wall of the toner box 34, which is cleaned by a cleaner 39 supported by the rotary shaft 35.

The supply roller 33 is rotatably arranged at a side position with respect to the toner supply port 37. The development roller 31, which is opposed to the supply roller 33, is rotatably arranged. The supply roller 33 and the development roller 31 make mutual abutment in a state in which each of them is compressed to some extent.

The supply roller 33 is constructed such that a roller shaft made of metal is coated with a roller composed of a conductive foam material. The development roller 31 is constructed such that a roller shaft made of metal is coated with a roller composed of a conductive rubber material. More specifically, the roller portion of the development roller 31 is constructed such that the surface of a main roller body, which is composed of conductive urethane rubber or silicone rubber including carbon fine particles or the like, is coated with a coat layer which is composed of urethane rubber or silicone rubber containing fluorine. A predetermined development bias, which is biased with respect to the photosensitive drum 27, is applied to the development roller 31.

The layer thickness-regulating blade 32 is arranged in the vicinity of the development roller 31. The layer thickness-regulating blade 32 includes a pressing section 40 which has a semicircular cross section, which is composed of insulative silicone rubber, and which is disposed at the tip of a main blade body composed of a metal plate spring member. The layer thickness-regulating blade 32 is supported by the development cartridge 28 in the vicinity of the development roller 31 so that the pressing section 40 makes contact with the development roller 31 under the pressure by the aid of the elastic force of the main blade body.

The toner, which is discharged from the toner supply port 37, is supplied to the development roller 31 in accordance with the rotation of the supply roller 33. During this process, the toner is positively charged by the friction between the supply roller 33 and the development roller 31. Further, the toner, which is supplied onto the development roller 31, enters the space between the development roller 31 and the pressing section 40 of the layer thickness-regulating blade 32 in accordance with the rotation of the development roller 31, wherein the toner is sufficiently charged by the friction. The toner is carried as a thin layer having a constant thickness on the development roller 31.

The photosensitive drum 27 is rotatably arranged at a side position with respect to the development roller 31 so that the photosensitive drum 27 is opposed to the development roller 31. The photosensitive drum 27 has a main drum body which is grounded. The photosensitive drum 27 has its surface portion which is formed by a positively chargeable photosensitive layer composed of polycarbonate or the like.

The scorotron type charger 29 is arranged over the photosensitive drum 27 while being separated by a predetermined spacing distance so that the scorotron type charger 29 does not make contact with the photosensitive drum 27. The scorotron type charger 29 is a positively charging charger of the scorotron type in which the corona discharge is generated from a charging wire of tungsten or the like. The scorotron type charger 29 is constructed so that the surface of the photosensitive drum 27 is uniformly charged to have the positive polarity. It is established that the surface of the photosensitive drum 27 will have an initial charge electric potential of about 900 V by being charged by the scorotron type charger 29.

The conductive brush 51 is arranged at a side position with respect to the photosensitive drum 27 on a downstream side from the transfer roller 30 and on an upstream side from the scorotron type charger 29 in the direction of rotation of the photosensitive drum 27 so that the conductive brush 51 is opposed to the photosensitive drum 27. The conductive brush 51 is provided with a base member 54 which is composed of a substantially L-shaped metal material, and a brush 55 which is implanted on one end of the base member 54 and which is formed of a conductive material composed of acrylic resin dispersed with conductive filler or conductive particles such as carbon. The base member 54 is attached to a brush frame 56 of the drum cartridge 26 which extends on the side of the photosensitive drum 27. Accordingly, the brush 55 is arranged to make contact with the surface of the photosensitive drum 27.

A DC power source 53 is connected to the other end of the base member 54 of the conductive brush 51. A diode 52 for avoiding any countercurrent is provided between the base member 54 and the DC power source 53.

The DC power source 53 is provided in the main body casing, which is grounded and which is constructed so that a bias voltage of about 400 V is applied to the conductive brush 51. The diode 52 is also provided in the main body casing.

The surface of the photosensitive drum 27 is positively charged uniformly by the scorotron type charger 29. After that, the surface of the photosensitive drum 27 is subjected to the exposure by the high speed scanning with a laser beam emitted from a scanner unit (not shown) to form an electrostatic latent image on the basis of predetermined image data. More specifically, the predetermined electrostatic latent image is formed by the exposure so that the surface electric potential of the photosensitive drum is about 900 V at unexposed portions and about 200 V at exposed portions.

Subsequently, the toner, which is carried on the development roller 31 and which is positively charged, makes contact with the photosensitive drum 27 while being opposed thereto in accordance with the rotation of the development roller 31. In this situation, the toner is supplied to the electrostatic latent image formed on the surface of the photosensitive drum 27, i.e., to the exposed portions which have been exposed with the laser beam and which have the lowered electric potential, of the surface of the photosensitive drum 27 which had been positively charged uniformly. The toner is selectively carried, and thus a visible image is formed. Accordingly, the reversal development is achieved.

The transfer roller 30 is arranged under the photosensitive drum 27 so that the transfer roller 30 is opposed to the photosensitive drum 27. The transfer roller 30 is rotatably supported by the drum cartridge 26. The transfer roller 30 has a roller shaft made of metal which is coated with a roller composed of a conductive rubber material. The transfer roller 30 is constructed so that a predetermined transfer bias is applied with respect to the photosensitive drum 27 during the transfer. Therefore, the visible image, which is carried on the surface of the photosensitive drum 27, is transferred to the printing paper during a period in which the printing paper passed through the space between the photosensitive drum 27 and the transfer roller 30. Further, as a result of the transfer effected by the transfer roller 30, the unexposed portions have a charge electric potential of about 300 V after the transfer on the surface of the photosensitive drum 27.

The process unit having the structure as described above performs the development in accordance with the non-magnetic mono-component developing system. Both of the development roller 31 and the supply roller 33 are composed of the materials having no magnetization. The development roller 31 abuts against the photosensitive drum 27. Further, any cleaning blade is not provided to remove the toner remaining on the photosensitive drum 27. The so-called cleaner-less electrostatic development process is constructed.

The toner box 34 of the printer provided with the process unit as described above was filled with each of Toners 1 to 22 described above to carry out the transfer residue test in accordance with the following procedure. At first, the printing is forcibly stopped during the solid printing, and the development cartridge 28 is detached from the drum cartridge 26. The toner (hereinafter referred to as “transfer residue toner”), which remains on the portion of the photosensitive drum 27 immediately after the transfer, is adhered to an adhesive tape (Scotch Mending Tape 810-3-18 produced by Sumitomo 3M). The adhesive tape, which has been subjected to the adhesion, is stuck to the printing paper (Xerox 4200) to measure the whiteness degree S by using a whiteness meter (produced by Nippon Denshoku). The same adhesive tape except that the toner is not adhered thereto is stuck to the same printing paper to measure the whiteness degree R thereof. An index value R—S of the transfer residue is calculated from the whiteness degrees S, R.

Results are shown in Table 4 below.

TABLE 4

| | Transfer residue index value |
|---|---|
| Toner 1 | 1.0 |
| Toner 2 | 2.0 |
| Toner 3 | 0.4 |
| Toner 4 | 0.9 |
| Toner 5 | 1.2 |
| Toner 6 | 1.2 |
| Toner 7 | 1.5 |
| Toner 8 | 2.2 |
| Toner 9 | 1.1 |
| Toner 10 | 2.0 |
| Toner 11 | 2.4 |
| Toner 12 | — |
| Toner 13 | — |
| Toner 14 | 4.5 |
| Toner 15 | 6.7 |
| Toner 16 | 30.9 |
| Toner 17 | 8.0 |
| Toner 18 | 3.7 |
| Toner 19 | 5.0 |
| Toner 20 | 18.6 |
| Toner 21 | 20.4 |
| Toner 22 | 18.6 |

According to Table 4 above, it is understood that the transfer residue index values of Toners 1 to 11 exhibit extremely low values of 0.4 to 2.4. In particular, the transfer residue index values were less than 2.0 in the case of Toners 1, 3 to 7, and 9. When the transfer residue index value is not more than about 3.0, any ghost (afterimage) cannot be confirmed visually at all at this level. Therefore, the following fact is affirmed. That is when any one of Toners 1 to 11 is used, then the transfer failure is not caused on the recording medium even in the case of the printer which adopts the cleaner-less electrostatic development process, and it is possible to improve the quality of the image to be recorded on the recording medium.

On the other hand, it is understood that the transfer residue index values of Toners 12 to 22 exhibit values of 3.7 to 30.9, and the transfer residue toner cannot be suppressed as compared with Toners 1 to 11. If the toner, which remains on the photosensitive drum 27, is increased to this level, then the toner, which is not recovered by the development roller 31, exists, and the problem of the ghost (afterimage) or the like is caused thereby.

Therefore, it is affirmed that Toners 1 to 11 are preferred as the toner to be used in the development process based on the non-magnetic mono-component developing system. The following fact is appreciated. That is, in order to select Toners 1 to 11 as described above, it is appropriate to select, from Coloring agents 1 to 21 shown in Table 2 above, Coloring agents 1 to 10 which express that pH is 5.3 to 7.7, the surface coating ratio with the coupling agent is 26.7 to 81.6%, and the bulk change ratio is 30.9 to 50.0%. In particular, in order to achieve the low value of the transfer residue index value of the toner of less than 2.0, it is possible to select Toners 1, 3 to 7, and 9 which express that pH is 5.3 to 7.5, the surface coating ratio with the coupling agent is 41.7 to 81.6%, and the bulk change ratio is 32.7 to 50.0%.

The embodiments of the present invention have been explained above. However, the present invention is not limited to the exemplary specified embodiments described above, which can be also carried out in other various forms. For example, the foregoing embodiments include several embodiments in which the specified substances are contained at the specified blending ratios. However, as explained in the summary and the description of the preferred embodiments, the present invention can be also carried out by utilizing substances other than the substances used in the foregoing embodiments. For example, the blending ratios thereof can be also regulated arbitrarily to obtain the coloring agent which expresses that pH is 5.3 to 7.7, the surface coating ratio with the coupling agent is 26.7 to 81.6%, and the bulk change ratio is 30.9 to 50.0%.

1. A method for evaluating a coloring agent to be blended into a toner for electrostatic latent image development, wherein the coloring agent is formed of iron oxide to which a surface treatment is applied with a coupling agent to make a surface hydrophobic, the method comprising:
measuring pH of the coloring agent;
calculating a surface coating ratio of the coloring agent with the coupling agent;
determining a bulk change ratio of the coloring agent; and
selecting the coloring agent which expresses that pH is 5.3 to 7.7, the surface coating ratio with the coupling agent is 26.7 to 81.6%, and the bulk change ratio is 30.9 to 50.0%.

2. The method for evaluating the coloring agent according to claim 1, wherein the coupling agent is a silane-based coupling agent.

3. The method for evaluating the coloring agent according to claim 2, wherein the silane-based coupling agent is selected from the group consisting of γ-methacryloxypropyldiethoxysilane, γ-methacryloxypropyltriethoxysilane, decyltrimethoxysilane, hexyltrimethoxysilane, and hexyltriethoxysilane.

4. The method for evaluating the coloring agent according to claim 1, wherein pH of the coloring agent is 5.3 to 7.5, the surface coating ratio with the coupling agent is 41.7 to 81.6%, and the bulk change ratio is 32.7 to 50.0%.

5. A coloring agent to be blended into a toner for electrostatic latent image development, the coloring agent being formed of iron oxide to which a surface treatment is applied with a coupling agent to make a surface hydrophobic, wherein pH is 5.3 to 7.7, a surface coating ratio with the coupling agent is 26.7 to 81.6%, and a bulk change ratio is 30.9 to 50.0%.

6. The coloring agent according to claim 5, wherein the coupling agent is a silane-based coupling agent.

7. The coloring agent according to claim 6, wherein the silane-based coupling agent is selected from the group consisting of γ-methacryloxypropyldiethoxysilane, γ-methacryloxypropyltriethoxysilane, decyltrimethoxysilane, hexyltrimethoxysilane, and hexyltriethoxysilane.

8. The coloring agent according to claim 5, wherein pH of the coloring agent is 5.3 to 7.5, the surface coating ratio with the coupling agent is 41.7 to 81.6%, and the bulk change ratio is 32.7 to 50.0%.

9. A toner for electrostatic latent image development, comprising:
a coloring agent; and
a binder resin, wherein:
the coloring agent is formed of iron oxide to which a surface treatment is applied with a coupling agent to make a surface hydrophobic, and the coloring agent expresses that pH is 5.3 to 7.7, a surface coating ratio with the coupling agent is 26.7 to 81.6%, and a bulk change ratio is 30.9 to 50.0%.

10. The toner for electrostatic latent image development according to claim 9, wherein the coupling agent is a silane-based coupling agent.

11. The toner for electrostatic latent image development according to claim 10, wherein the silane-based coupling agent is selected from the group consisting of γ-methacryloxypropyldiethoxysilane, γ-methacryloxypropyltriethoxysilane, decyltrimethoxysilane, hexyltrimethoxysilane, and hexyltriethoxysilane.

12. The toner for electrostatic latent image development according to claim 9, wherein a transfer residue index value of the toner is not more than 3.0.

13. The toner for electrostatic latent image development according to claim 9, wherein pH of the coloring agent is 5.3 to 7.5, the surface coating ratio with the coupling agent is 41.7 to 81.6%, and the bulk change ratio is 32.7 to 50.0%.

14. The toner for electrostatic latent image development according to claim 9, wherein a blending amount of the coloring agent is 25 to 30% by weight.
